(19) United States
(12) Patent Application Publication
(10) Pub. No.: US 2025/0197113 A1
(43) Pub. Date: Jun. 19, 2025

(54) SYSTEMS AND METHODS FOR PROVIDING ORDER FULFILLMENT USING A RECIRCULATING ROUTING SYSTEM

(71) Applicant: Berkshire Grey Operating Company, Inc., Bedford, MA (US)

(72) Inventors: Prasanna Velagapudi, Pittsburgh, PA (US); Joseph Romano, Arlington, MA (US); Christopher Geyer, Arlington, MA (US); Guoming Alex Long, Wexford, PA (US); Thomas Allen, Reading, MA (US); Christopher Buck, Stow, MA (US)

(21) Appl. No.: 19/068,214

(22) Filed: Mar. 3, 2025

Related U.S. Application Data
(63) Continuation of application No. 17/193,384, filed on Mar. 5, 2021, now Pat. No. 12,269,682.
(60) Provisional application No. 62/986,414, filed on Mar. 6, 2020.

(51) Int. Cl. B65G 1/04; G06T 7/50; G06T 7/70; H04N 7/18

(52) U.S. Cl. CPC B65G 1/0485; B65G 1/0407; G06T 7/50; G06T 7/70; H04N 7/18

(57) ABSTRACT

A storage, retrieval and processing system is disclosed for processing objects. The storage, retrieval and processing system includes a plurality of bins including objects to be distributed, the plurality of bins being provided on a conveyance system, a programmable motion device that includes an end effector for grasping and moving any of the objects, the programmable motion device being capable of reaching any of the objects within at least one of the plurality of bins in an input area of the conveyance system, a perception system for providing perception data regarding a selected object that is presented to the perception system by the programmable motion device, and a routing conveyance system including a track-mounted shuttle for receiving the selected object, and for moving the selected object in each of horizontal and vertical directions toward a destination container responsive to the perception data.

### PRIORITY

The present application is a continuation of U.S. patent application Ser. No. 17/193,384, filed Mar. 5, 2021, which claims priority to U.S. Provisional Patent Application No. 62/986,414 filed Mar. 6, 2020, the disclosure of which is hereby incorporated by reference in its entirety.

### BACKGROUND

The present invention relates to order fulfillment systems, and relates in particular to systems for providing aggregation of objects (e.g., products, packages, bags, items, goods etc.) for preparation for shipment to destination locations, such as in Automated Storage and Retrieval Systems.

Order fulfillment systems typically involve the processing of a wide variety of objects for distribution to a large number of distribution locations, such as intermediate distribution stations, mail order stations, geographic group locations and address specific locations. Automated storage and retrieval systems (AS/RS) generally include computer-controlled systems of automatically storing (placing) and retrieving items from defined storage locations. Traditional AS/RS typically employ totes (or bins), which are the smallest unit of load for the system. In these systems, the totes are brought to people who pick individual items out of the totes. When a person has picked the required number of items out of the tote, the tote is then re-inducted back into the AS/RS.

In these traditional systems, the totes are brought to a person, and the person may either remove an item from the tote or add an item to the tote. The tote is then returned to the storage location. Such systems, for example, may be used in libraries and warehouse storage facilities. The AS/RS involves no processing of the items in the tote, as a person processes the objects when the tote is brought to the person. This separation of jobs allows any automated transport system to do what it is good at—moving totes—and the person to do what the person is better at-picking items out of cluttered totes. It also means the person may stand in one place while the transport system brings the person totes, which increases the rate at which the person can pick goods.

There are limits however, on such conventional systems in terms of the time and resources required to move totes toward and then away from each person, as well as how quickly a person can process totes in this fashion in applications where each person may be required to process a large number of totes. There remains a need therefore, for an AS/RS that stores and retrieves objects more efficiently and cost effectively, yet also assists in the processing of a wide variety of objects.

### SUMMARY

In accordance with an aspect, the invention provides a storage, retrieval and processing system for processing objects. The storage, retrieval and processing system includes a plurality of bins including objects to be distributed, the plurality of bins being provided on a conveyance system, a programmable motion device that includes an end effector for grasping and moving any of the objects, the programmable motion device being capable of reaching any of the objects within at least one of the plurality of bins in an input area of the conveyance system, an object perception unit for providing perception data regarding a selected object that is presented to the object perception unit by the programmable motion device, and a routing conveyance system including a track-mounted shuttle for receiving the selected object, and for moving the selected object in each of horizontal and vertical directions toward a destination container responsive to the perception data.

In accordance with another aspect, the invention provides a storage, retrieval and processing system for processing objects that includes a plurality of bins including objects to be distributed, the plurality of bins being provided on an input conveyance system, a programmable motion device that includes an end effector for grasping and moving any of the objects, a routing conveyance system including a routing track-mounted shuttle for receiving the selected object, and for moving the selected object toward a first side of any of a plurality of destination containers, and a destination container removal system for removing completed destination containers, the destination container removal system including a container conveyance system including a removal track-mounted shuttle for acquiring a completed destination container of the plurality of destination containers from a second side of the completed destination container, the second side being opposite the first side of the completed destination container.

In accordance with a further embodiment, the invention provides a method of providing storage, retrieval and processing of objects that includes providing on a conveyance system a plurality of bins including objects to be distributed, grasping and moving objects within at least one of the plurality of bins in an input area of the conveyance system using a programmable motion device that includes an end effector for grasping and moving any of the objects, the programmable motion device being capable of reaching any of the objects within at least one of the plurality of bins in an input area of the conveyance system, providing perception data regarding a selected object that is presented to the object perception unit by the programmable motion device, and routing the selected object in each of horizontal and vertical directions on a track mounted shuttle as the track-mounted shuttle moves about a circuit toward a destination container responsive to the perception data.

### BRIEF DESCRIPTION OF THE DRAWINGS

The following description may be further understood with reference to the accompanying drawings in which:

FIG. 1 shows an illustrative diagrammatic front isometric view of a storage, retrieval and processing system in accordance with an aspect of the present invention;

FIG. 2 shows an illustrative diagrammatic enlarged view of an intake portion of the system of FIG. 1;

FIG. 3 shows an illustrative diagrammatic underside view of the bin perception unit of FIGS. 1 and 2;

FIG. 4 shows an illustrative diagrammatic view from the bin perception unit of FIG. 3 directed a bin and its contents;

FIG. 5 shows an illustrative diagrammatic enlarged view of the object perception unit of the system of FIG. 1;

FIG. 6 shows an illustrative diagrammatic front elevated view of the object perception unit of FIGS. 1 and 5;

FIG. 7 shows an illustrative diagrammatic rear elevated view of the object perception unit of FIGS. 1 and 5;

FIGS. 8A and 8B show illustrative diagrammatic views of a routing conveyor system in the processing system of FIG. 1, showing an object being loaded (FIG. 8A) and brought to a destination container (FIG. 8B);

FIGS. 9A and 9B show illustrative diagrammatic views of an object being moved from a routing conveyor system (FIG. 9A) into a destination container (FIG. 9B);

FIGS. 10A and 10B show illustrative diagrammatic views of a container movement system retrieving a completed destination container (FIG. 10A) and subsequently moving toward an output conveyor (FIG. 10B);

FIGS. 11A and 11B show illustrative diagrammatic views of the container movement system of FIGS. 10A and 10B moving the completed destination container away from the plurality of destination containers (FIG. 11A) toward the output conveyor (FIG. 11B);

FIGS. 12A and 12B show illustrative diagrammatic views of the completed destination container of FIGS. 11A and 11B being moved onto the output conveyor (FIG. 12A) and subsequently along the output conveyor (FIG. 12B);

FIGS. 13A and 13B show illustrative diagrammatic views of an empty destination container being moved toward (FIG. 13A) and subsequently onto the container movement system (FIG. 13B);

FIG. 14 shows an illustrative diagrammatic view of the empty destination container of FIGS. 13A and 13B being moved toward a container storage location;

FIG. 15 shows an illustrative diagrammatic view of the empty destination container of FIG. 14 being moved into a container storage location; and

FIG. 16 shows an illustrative diagrammatic opposite side view of the system of FIG. 1.

The drawings are shown for illustrative purposes only.

### DETAILED DESCRIPTION

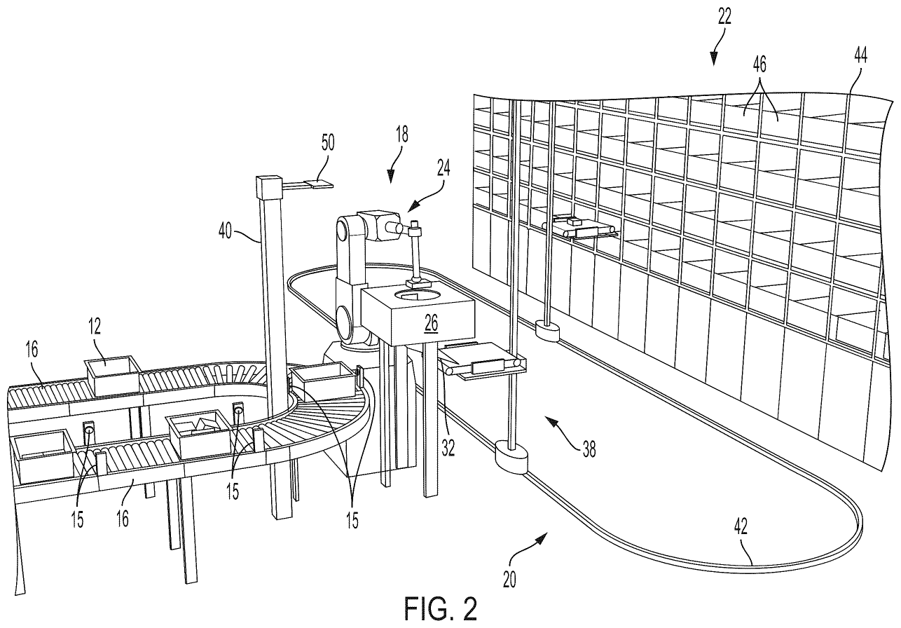

In accordance with an aspect, the invention provides an ASRS system 10 in which objects are provided in a plurality of bins 12 at an input area 14 of an input conveyance system 16. Objects are processed at a processing station 18, then routed via a routing conveyance system 20 to any of a plurality of destination containers at a destination area 22. The processing station 18 may include a programmable motion device 24, a bin perception unit 50 and an object perception unit 26. Generally, objects are provided to the input area 14 in bins 12, are moved by a programmable motion device 24 to an object perception unit 26, fall to an object conveyance shuttle unit 38 of an object routing system for routing to any of a plurality of destination containers 46 in container array 44. Empty containers are provided to the container array 44, and completed containers are removed from the container array, by a container movement system adjacent an output conveyor 48. With reference to FIG. 2, the input conveyor 16 may include a plurality of detectors 15 that monitor movement of the conveyors, and may confirm the identity and positon of a conveyor at the input area 14 for processing at the processing station 18.

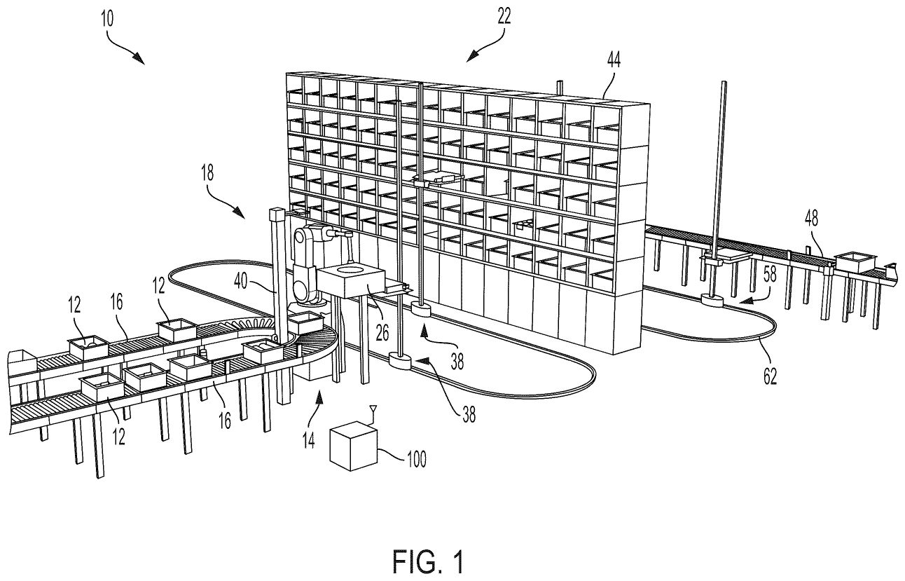

The operations of the system are coordinated with a central control system 100 as shown in FIG. 1 that communicates wirelessly with each of the conveyors and conveyor sensors, the programmable motion device 24, the detectors 15, the perception units 26 and 50, as well as all elements of the routing conveyance system, container arrays, container movement systems, and output conveyance systems (all components and systems). The bin perception unit 50 aids in grasping objects from the bins 12 with an end effector of the programmable motion device. Once grasped by the programmable motion device, the object is dropped into the object perception unit 26, and the system thereby determines from symbol strings the UPC associated with the object, as well as the outbound destination for each object. The central control system 100 is comprised of one or more workstations or central processing units (CPUs). For example, the correspondence between UPCs or mailing labels, and outbound destinations is maintained by a central control system in a database called a manifest. The central control system maintains the manifest by communicating with a warehouse management system (WMS). The manifest provides the outbound destination for each in-bound object.

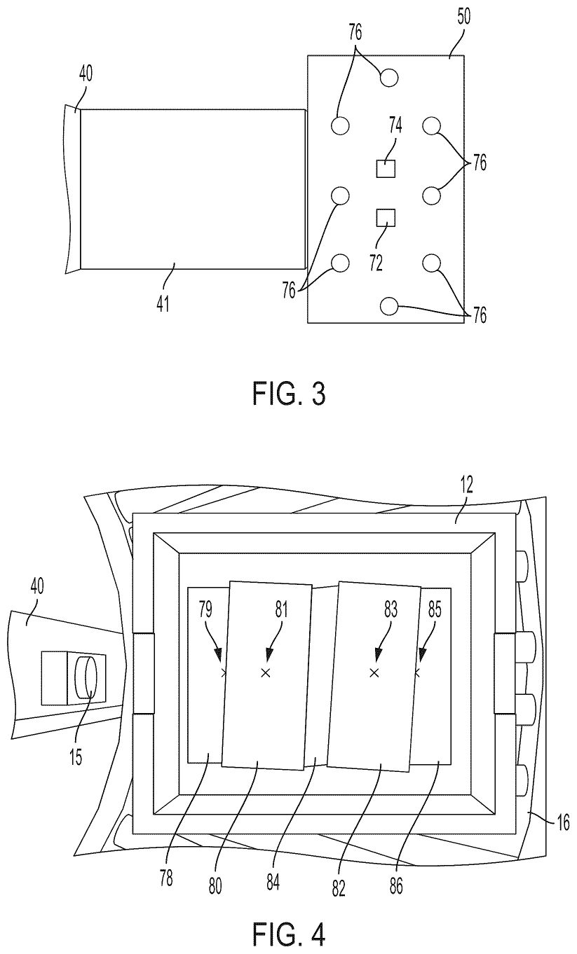

In particular, the system of an aspect includes a bin perception unit 50 that is mounted above a bin of objects to be processed next to the articulated arm 24, looking down into a bin 12. The system 50, for example and as shown in FIG. 3, may be attached via a mount 41 to a bin perception unit stand 40, and may include (on the underside thereof), a camera 72, a depth sensor 74 and lights 76. A combination of 2D and 3D (depth) data is acquired. The depth sensor 74 may provide depth information that may be used together with the camera image data to determine depth information regarding the various objects in view. The lights 76 may be used to remove shadows and to facilitate the identification of edges of objects, and may be all on during use, or may be illuminated in accordance with a desired sequence to assist in object identification. The system uses this imagery and a variety of algorithms to generate a set of candidate grasp locations for the objects in the bin as discussed in more detail below.

FIG. 4 shows an image view from the bin perception unit 50. The image view shows a bin 12 in the input area 14 (a conveyor), and the bin 12 contains objects 78, 80, 82, 84 and 86. In the present embodiment, the objects are homogenous, and are intended for distribution to different break-pack packages. Superimposed on the objects 78, 80, 82, 84, 86 (for illustrative purposes) are anticipated grasp locations 79, 81, 83 and 85 of the objects. Note that while candidate grasp locations 79, 83 and 85 appear to be good grasp locations, grasp locations 79, 85 do not because each associated object is at least partially underneath another object. The system may also not even try to yet identify a grasp location for the object 84 because the object 84 is too obscured by other objects. Candidate grasp locations may be indicated using a 3D model of the robot end effector placed in the location where the actual end effector would go to use as a grasp location. Grasp locations may be considered good, for example, if they are close to the center of mass of the object to provide greater stability during grasp and transport, and/or if they avoid places on an object such as caps, seams etc. where a good vacuum seal might not be available.

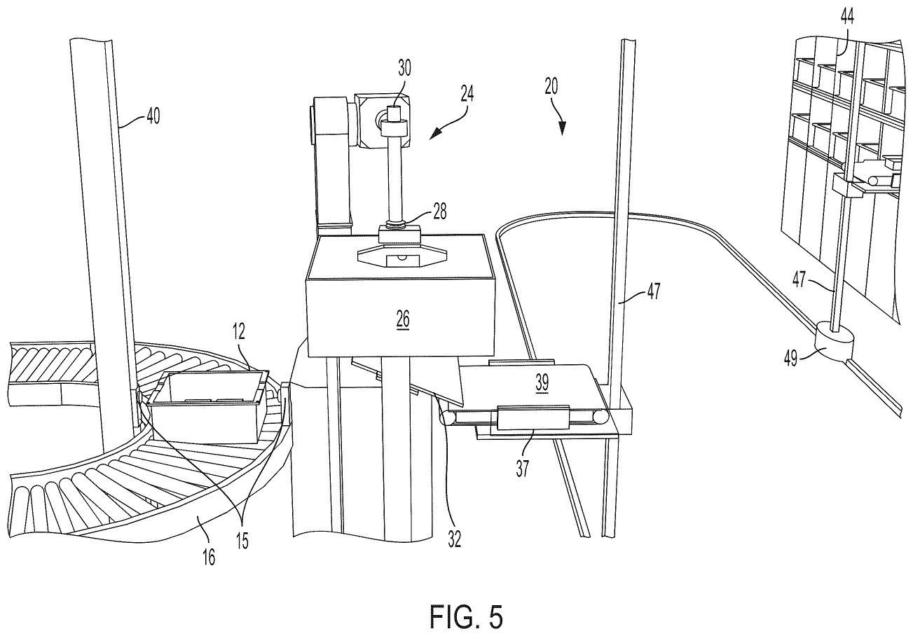

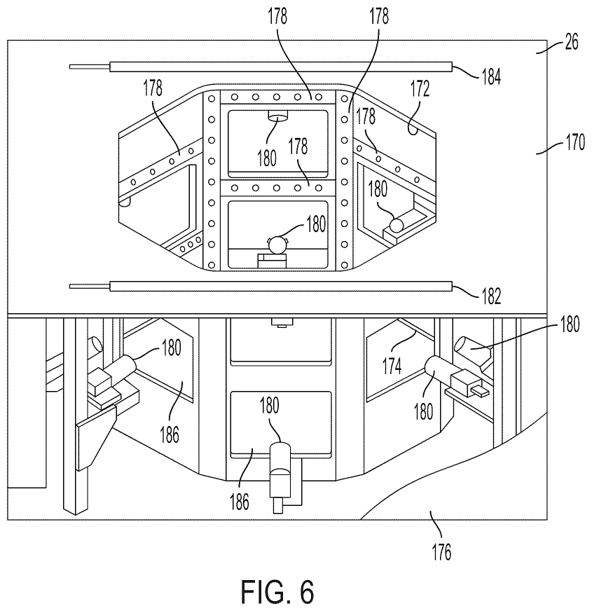

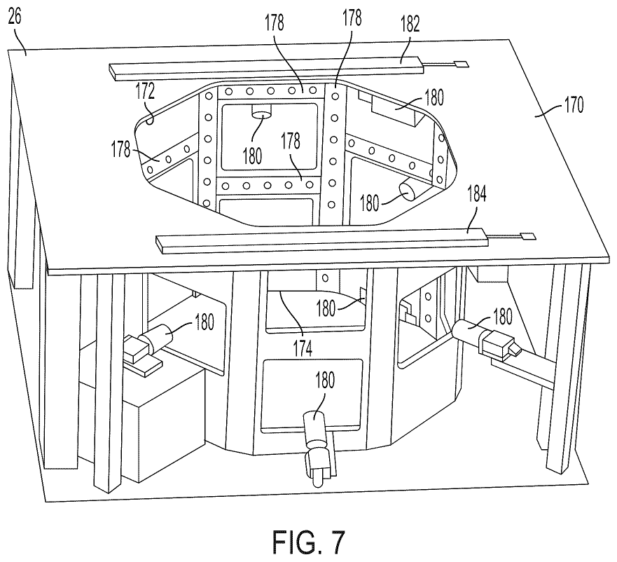

With reference to FIG. 5, the programmable motion device 24 includes an end effector 28 that is coupled via a hose mount 30 to a vacuum hose attached to a vacuum source. With further reference to FIGS. 6 and 7, the object perception unit 26 includes a structure 170 having a top opening 172 and a bottom opening 174, and the walls may be covered by an enclosing material 176 (e.g., a colored covering such as orange plastic, to protect humans from potentially dangerously bright lights within the object perception unit 26) as shown in FIGS. 5 and 6. The structure 170 includes a plurality of rows of sources (e.g., illumination sources such as LEDs) 178 as well as a plurality of image capturing units (e.g., cameras) 180. The sources 178 are provided in rows, and each is directed toward the center of the opening. The cameras 180 are also generally directed toward the opening, although some cameras are directed horizontally, while others are directed upward, and some are directed downward. The system also includes an entry source (e.g., infrared source) 182 as well as an entry detector (e.g., infrared detector) 184 for detecting when an object has entered the object perception unit 26. The LEDs and cameras therefore encircle the inside of the structure 170, and the cameras are positioned to view the interior via windows that may include a glass or plastic covering (e.g., 186).

An important aspect of systems of certain embodiments of the present invention, is the ability to identify via barcode or other visual markings of objects, unique indicia associated with the object by employing an object perception unit into which objects may be dropped. Automated scanning systems would be unable to see barcodes on objects that are presented in a way that their barcodes are not exposed or visible. The object perception unit may be used in certain embodiments, with a robotic system that may include a robotic arm equipped with sensors and computing, that when combined is assumed herein to exhibit the following capabilities: (a) it is able to pick objects up from a specified class of objects, and separate them from a stream of heterogeneous objects, whether they are jumbled in a bin, or are singulated on a motorized or gravity conveyor system; (b) it is able to move the object to arbitrary places within its workspace; (c) it is able to place objects in an outgoing bin or shelf location in its workspace; and, (d) it is able to generate a map of objects that it is able to pick, represented as a candidate set of grasp points in the workcell, and as a list of polytopes enclosing the object in space.

The allowable objects are determined by the capabilities of the robotic system. Their size, weight and geometry are assumed to be such that the robotic system is able to pick, move and place them. These may be any kind of ordered goods, packages, parcels, or other articles that benefit from automated sorting. Each object is associated with unique indicia such as a unique code (e.g., barcode) or a unique destination (e.g., address) of the object.

The manner in which inbound objects arrive may be for example, in one of two configurations: (a) inbound objects arrive piled in bins of heterogeneous objects; or (b) inbound articles arrive by a moving conveyor. The collection of objects includes some that have exposed bar codes and other objects that do not have exposed bar codes. The robotic system is assumed to be able to pick items from the bin or conveyor. The stream of inbound objects is the sequence of objects as they are unloaded either from the bin or the conveyor. With reference to FIG. 5, after an object has been dropped through the object perception unit 26, it is guided by a guide chute 32 onto the routing conveyance system 20.

The manner in which outbound objects are organized is such that objects are placed in a bin, shelf location or container, into which all objects corresponding to a given order are consolidated. These outbound destinations may be arranged in vertical arrays, horizontal arrays, grids, or some other regular or irregular manner, but which arrangement is known to the system. The robotic pick and place system is assumed to be able to place objects into all of the outbound destinations, and the correct outbound destination is determined from unique identifying indicia (identify or destination, such as a bar code or a unique address), which identifies the object or is destination.

It is assumed that the objects are marked in one or more places on their exterior with a visually distinctive mark such as a barcode or radio-frequency identification (RFID) tag so that they may be identified with a scanner. The type of marking depends on the type of scanning system used, but may include 1D or 2D barcode symbologies. Multiple symbologies or labeling approaches may be employed. The types of scanners employed are assumed to be compatible with the marking approach. The marking, either by barcode, RFID tag, or other means, encodes a symbol string, which is typically a string of letters and numbers. The symbol string uniquely associates the object with unique identifying indicia (identity or destination).

The operations of the systems described herein are coordinated by the central control system 100 as shown in FIG. 1. This system determines from symbol strings the unique indicia associated with an object, as well as the outbound destination for the object. The central control system is comprised of one or more workstations or central processing units (CPUs). The correspondence between unique identifying indicia and outbound destinations is maintained by the central control system in a database called a manifest. The central control system maintains the manifest by communicating with a warehouse management system (WMS).

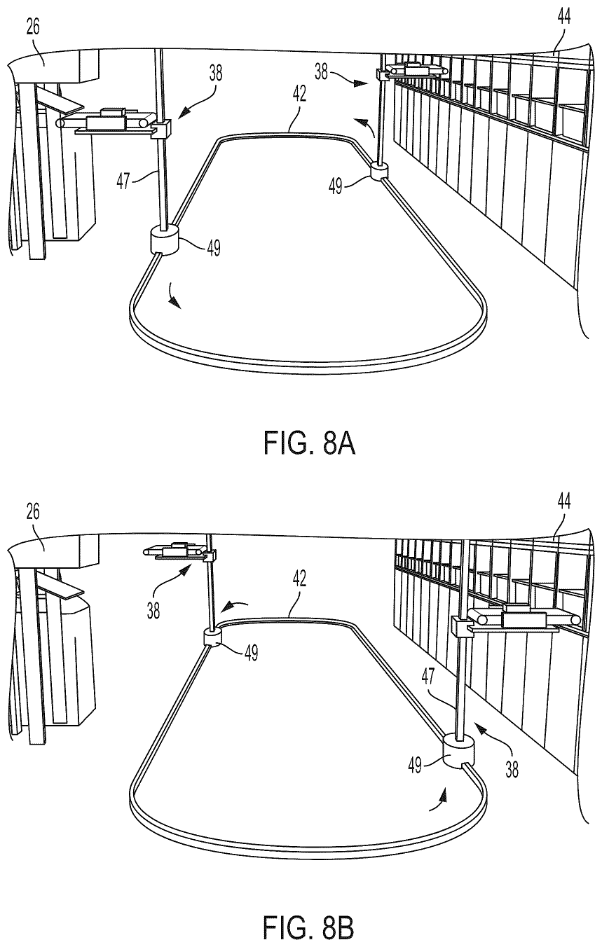

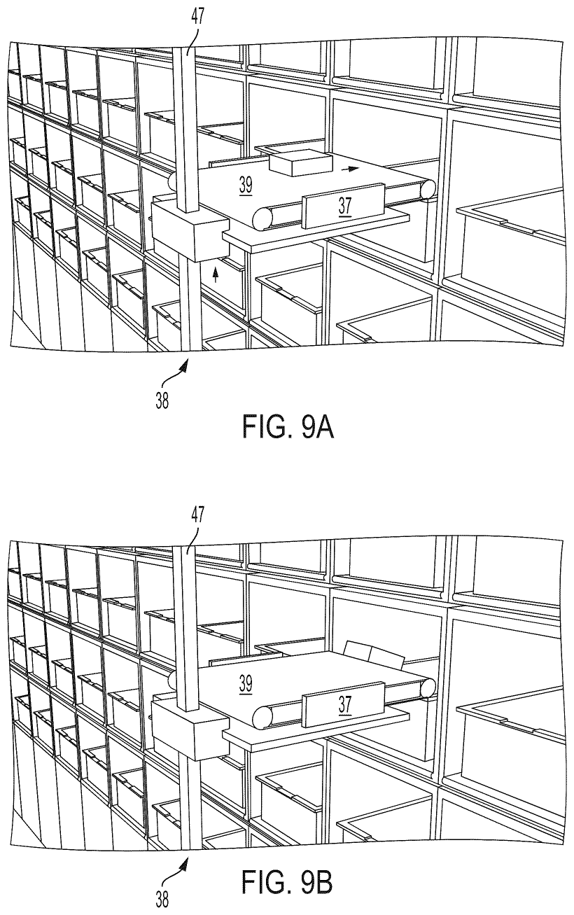

With reference to FIGS. 8A and 8B, the object conveyance shuttle unit 38 of the routing conveyance system receives objects (e.g., a singulated stream of objects) from the object feed system including the object perception unit 26. The routing conveyance system includes the object conveyance shuttle units 38 that run in a circuit along a track 42 proximate the array 44 of the plurality of destination containers. Each unit 38 includes a conveyor 39 mounted on a frame 37, and the frame 37 is vertically movable mounted on an elevator rod 47 that extends upward from a shuttle base 49 that is adapted to travel along the track 42. After an object is loaded onto a conveyor 39 of a unit 38 (as shown in FIG. 8A), the unit 38 is moved toward the array 44 of the plurality of destination containers (FIG. 8B). Once the conveyance shuttle unit is positioned along the track 42 and vertically adjacent the destination location (FIG. 9A), the conveyor 39 is actuated to move the object into the selected destination container (FIG. 9B).

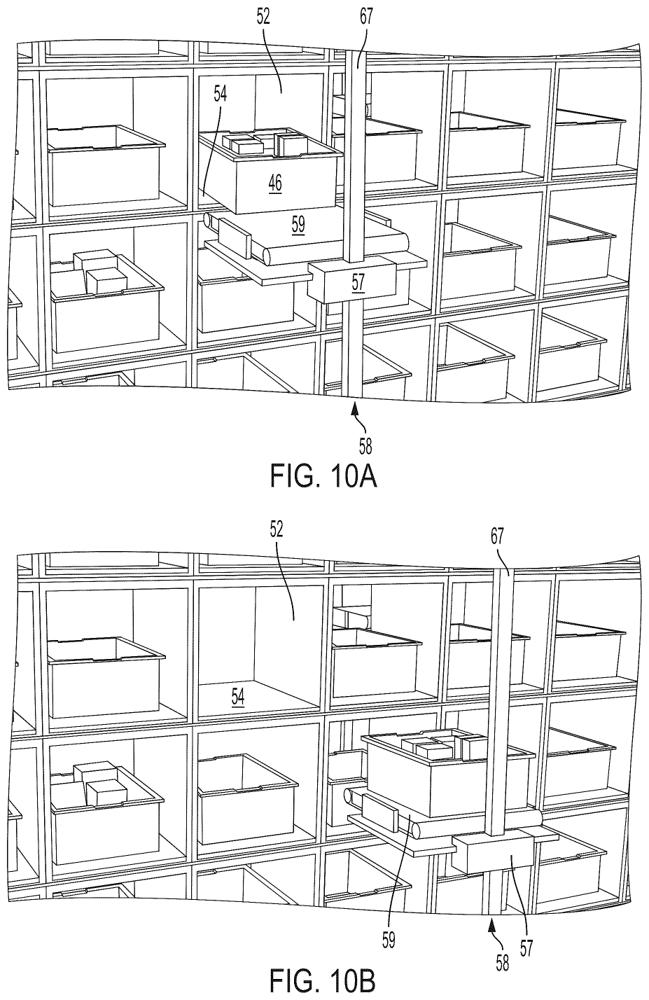

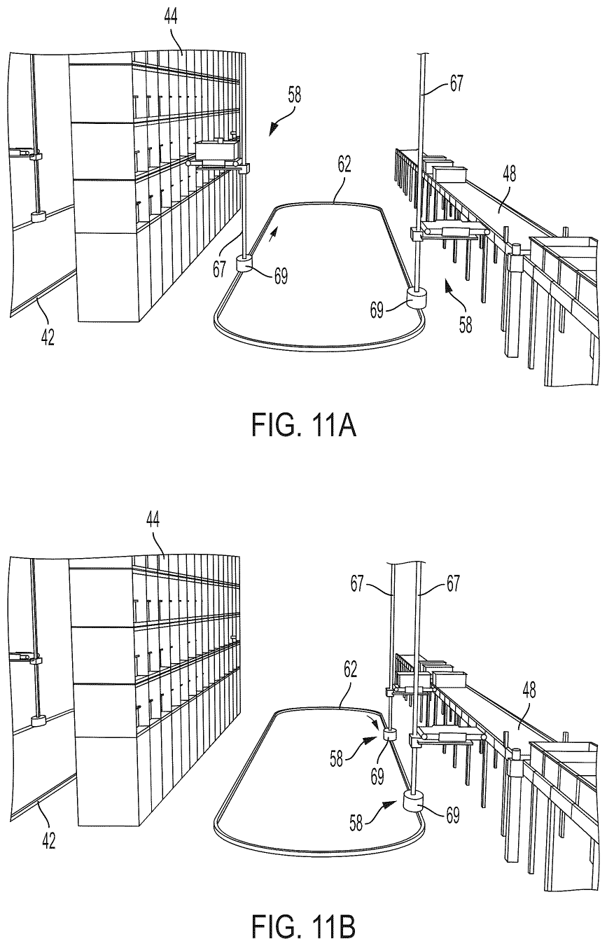

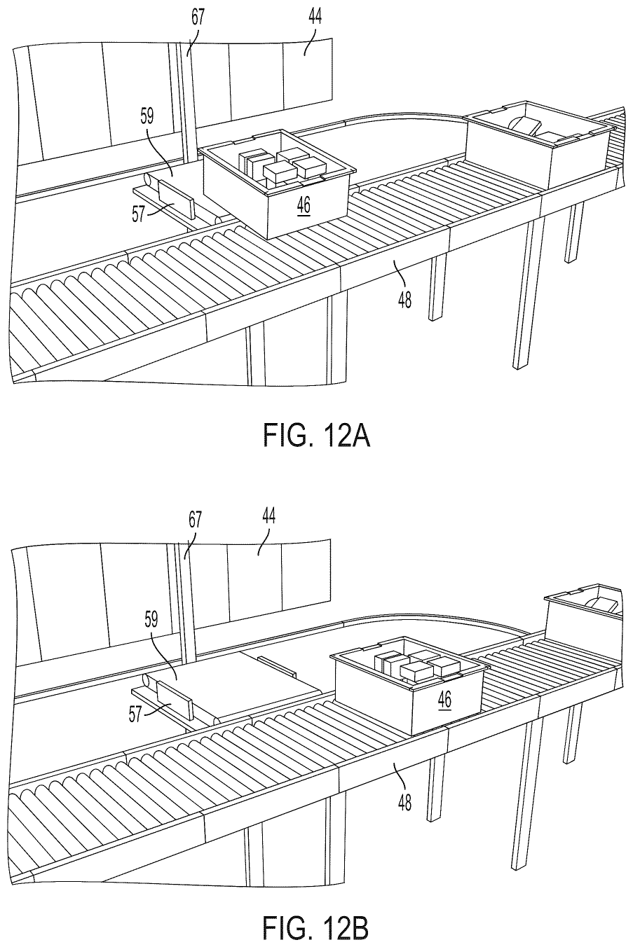

The opposite side of each of the destination containers 46 in the array 44 from which the objects are loaded into the destination containers may also be open, and may be accessed by a container movement system. FIGS. 10A and 10B shows a container movement system 58 that includes a container conveyor 59 on a structure 57 that is mounted for vertical movement along an elevator rod 67 (that is mounted at a lower end thereof to a shuttle base 69 shown in FIGS. 11A and 11B). With reference to FIG. 10A, each destination container location 52 includes an associated location container conveyor 54, and the conveyor 54 moves a completed destination container 46 toward a container conveyor 59 (FIG. 10A) on a container movement system, which then moves the completed container (FIG. 10B) toward an output conveyor 48 as shown in FIGS. 11A and 11B. With reference to FIGS. 12A and 12B, the completed destination container 46 is then moved using the container conveyor 59 from the container movement system 58 onto the output conveyor 48 (as shown in FIG. 12A), which brings the completed destination container (FIG. 12B) to an output processing location. Each of the objects is therefore moved vertically and horizontally by a routing conveyor unit, and then moved in a third direction by the container conveyor wherein the third direction is generally orthogonal to the first and second directions. The container may later be removed from the open storage location also along the third direction when completed as discussed in more detail below, and then moved horizontally and vertically for removal to an output conveyor. The movement of objects into destination containers at a first side of the destination containers, and having the completed destination containers removed from an opposite second side, permits the object conveyance system to continue to operate while destination containers are being replenished.

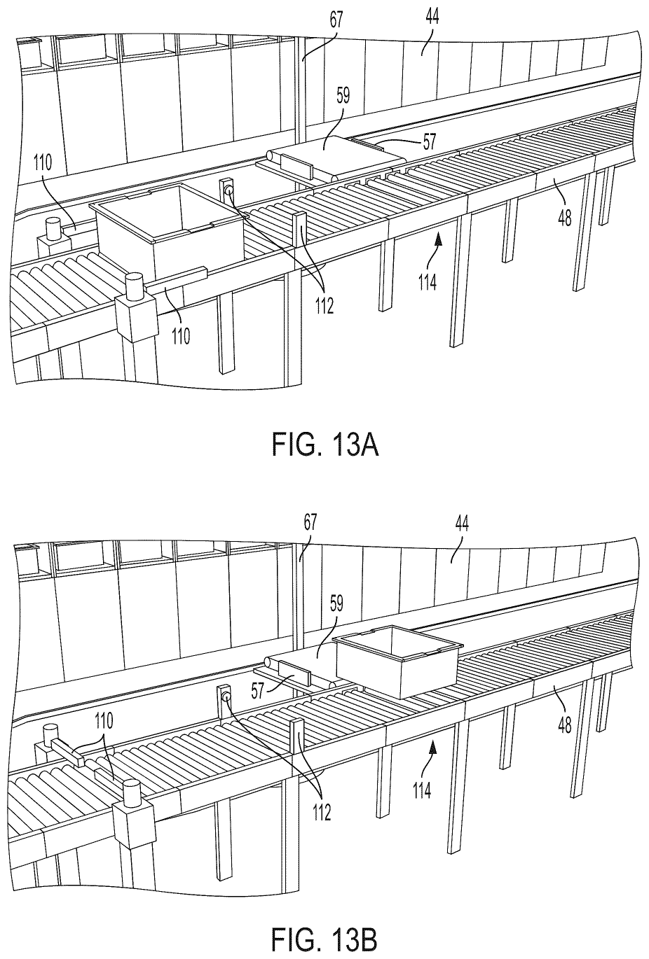

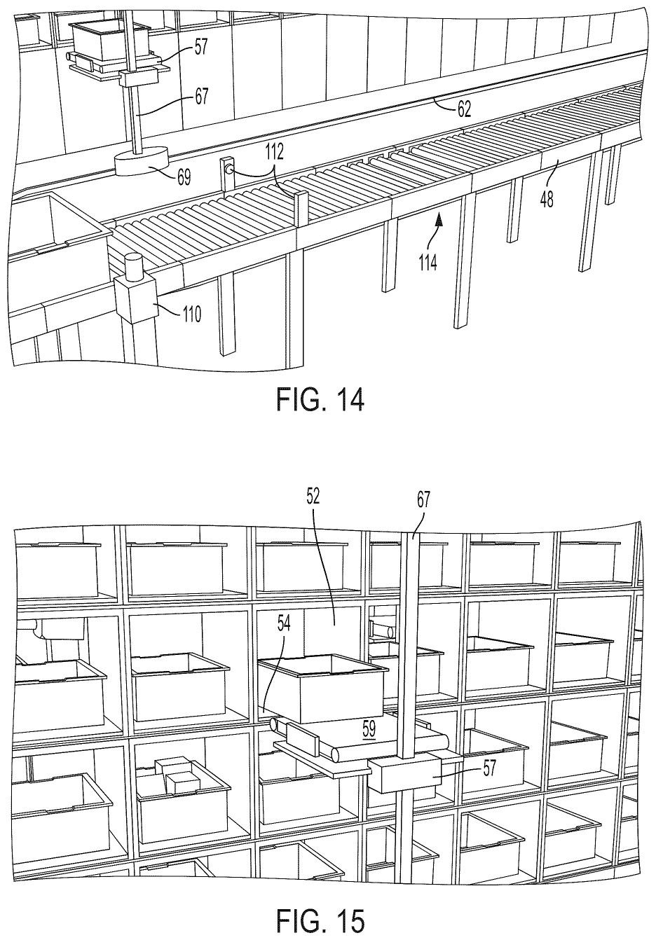

Empty destination containers are replenished to the array 44 using the container movement system 58 as well. In particular, and with reference to FIG. 13A, an empty destination container is provided through gates 110, and scanned for identification by detectors 112 (FIG. 13A). The empty destination container is then moved transversely from the output conveyor 48 using a bi-direction diverter 114, and the container conveyor 59 receives the empty destination container as shown in FIG. 13B. The container movement system 38 then moves the empty destination container along the track 62 circuit (as shown in FIG. 14) and upward so that the container conveyor 59 is adjacent the container location conveyor 54 of the empty container location 52 as shown in FIG. 15. The conveyor 59 and optionally the conveyor 54 work to move the empty container into the empty destination container location 52. In this way, empty destination containers may be populated into the array 44 as needed.

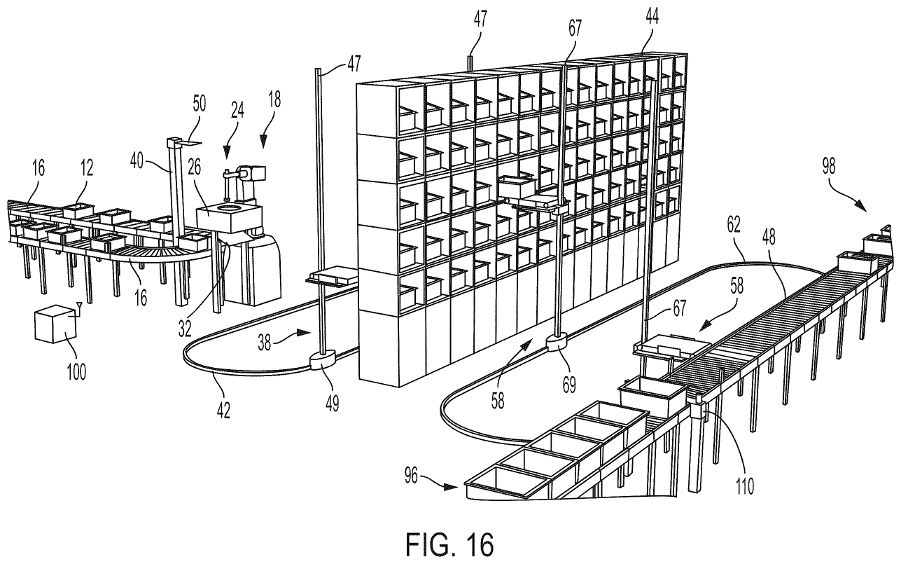

FIG. 16 shows an opposite side view of the system of FIG. 1, showing the output conveyor 48 that includes both empty containers at a first end 96, and completed destination containers being provided at an opposite second end 98. Again, the system is controlled by one or more computer processing systems 100, and sensors on the conveyors may be used to monitor the locations of bins and containers on each of the conveyors.

Those skilled in the art will appreciate that numerous modifications and variations may be made to the above disclosed embodiments without departing from the spirit and scope of the invention as claim.

What is claimed is:

1-24. (canceled)

25. A storage, retrieval and processing system for processing objects, said storage, retrieval and processing system comprising:
a plurality of bins including objects to be distributed, said plurality of bins being provided on an input conveyance system;
a programmable motion device that includes an end effector for grasping and moving any of the objects within at least one of the plurality of bins in an input area of the input conveyance system;
an object perception unit for providing perception data regarding a selected object that is presented to the object perception unit by the programmable motion device, the object perception unit including at least one camera;
a plurality of destination container locations in a vertically stacked array, each of the destination container locations including a container location conveyor for discharging a destination container stored thereon; and
a routing conveyance system including a first track-mounted shuttle and a second track-mounted shuttle, each of the first track-mounted shuttle and the second track-mounted shuttle accessible to the plurality of destination container locations, the first track-mounted shuttle and the second track-mounted shuttle each including a conveyor module mounted on a frame that is vertically movable on an elevator rod, the elevator rod extending upward from a shuttle base that is horizontally movable along a track circuit adjacent the vertically stacked array;
the first track-mounted shuttle accessible to the object perception unit and discharges any one of the objects in the destination container; and
the second track-mounted shuttle receiving the destination container discharged by the corresponding container location conveyor.

26. The storage, retrieval and processing system as claimed in claim 25, wherein the first track-mounted shuttle and the second track-mounted shuttle are provided on opposite sides of the vertical stacked array.

27. The storage, retrieval and processing system as claimed in claim 25, wherein the object perception unit includes a drop perception unit.

28. The storage, retrieval and processing system as claimed in claim 27, wherein the programmable motion device drops the selected object through the drop perception unit and onto first track-mounted shuttle.

29. The storage, retrieval and processing system as claimed in claim 25, further comprising an output conveyor and wherein the second track-mounted shuttle is accessible to the output conveyor.

30. The storage, retrieval and processing system as claimed in claim 29, wherein the second track-mounted shuttle replenishes the vertically stacked array with empty destination containers.

31. The storage, retrieval and processing system as claimed in claim 30, wherein empty containers are provided to the second track-mounted shuttle from the output conveyor.

32. A storage, retrieval and processing system for processing objects, said storage, retrieval and processing system comprising:
a plurality of bins including objects to be distributed, said plurality of bins being provided on an input conveyance system;
a programmable motion device that includes an end effector for grasping and moving any of the objects;
a plurality of destination container locations provided in a vertically stacked array, each of the plurality of destination container locations including a container location conveyor for discharging a container stored thereon;
a routing conveyance system including a first track-mounted shuttle for receiving a selected object and for moving the selected object toward the destination container and depositing it therein; and
a destination container removal system for removing completed destination containers, said destination container removal system including a second track-mounted shuttle for acquiring the destination container discharged by the corresponding container location conveyor;
each track-mounted shuttle including a conveyor module mounted on a frame that is vertically movable on an elevator rod, the elevator rod extending upward from a shuttle base that is horizontally movable along a respective track circuit adjacent the vertically stacked array.

33. The storage, retrieval and processing system as claimed in claim 32, wherein the first track-mounted shuttle and the second track-mounted shuttle are provided on opposite sides of the vertical stacked array.

34. The storage, retrieval and processing system as claimed in claim 32, wherein the object perception unit includes a drop perception unit.

35. The storage, retrieval and processing system as claimed in claim 34, wherein the programmable motion device drops the selected object through the drop perception unit and onto first track-mounted shuttle.

36. The storage, retrieval and processing system as claimed in claim 32, further comprising an output conveyor and wherein the second track-mounted shuttle is accessible to the output conveyor.

37. The storage, retrieval and processing system as claimed in claim 36, wherein the second track-mounted shuttle replenishes the vertically stacked array with empty destination containers.

38. The storage, retrieval and processing system as claimed in claim 37, wherein empty containers are provided to the second track-mounted shuttle from the output conveyor.

39. A method of providing storage, retrieval and processing of objects, said method comprising:
providing on an input conveyance system a plurality of bins including objects to be distributed;
grasping and moving objects within at least one of the plurality of bins in an input area of the input conveyance system using a programmable motion device that includes an end effector for grasping and moving any of the objects within at least one of the plurality of bins in an input area of the input conveyance system;
providing perception data regarding a selected object by an object perception unit, wherein the selected object is presented to the object perception unit by the programmable motion device, the object perception unit including at least one camera;
providing a plurality of destination container locations in a vertically stacked array, each of the destination container locations including a container location conveyor for discharging the destination container stored thereon;
routing the selected object in each of horizontal and vertical directions on a first track-mounted shuttle as the first track-mounted shuttle moves about a first track circuit and depositing the selected object in the destination container; and
discharging the destination container using the container location conveyor to a second track-mounted shuttle as the second track-mounted shuttle moves about a second track circuit,
wherein each of the first track-mounted shuttle and the second track-mounted shuttle includes a conveyor module mounted on a frame that is vertically movable on an elevator rod, the elevator rod extending upward from a shuttle base that is horizontally movable along the corresponding first or second track circuit, each adjacent the vertically stacked array.

40. The method as claimed in claim 39, further comprising an output conveyor accessible to the second track-mounted shuttle and wherein the second track-mounted shuttle deposits the destination container on the output conveyor using the conveyor module.

41. The method as claimed in claim 39, wherein the object perception unit includes a drop perception unit.

42. The method as claimed in claim 39, wherein the programmable motion device drops the selected object through the drop perception unit and onto first track-mounted shuttle.

43. The method as claimed in claim 39, wherein the programmable motion device includes an end-effector that is coupled to a vacuum source.

44. The method as claimed in claim 39, wherein the vertically stacked array is open on opposing sides thereof.
